(19) United States
(12) Patent Application Publication
(10) Pub. No.: US 2001/0025253 A1
(43) Pub. Date: Sep. 27, 2001

(54) Multi-level award program

(75) Inventors: Christopher J. Heintz, New York, NY (US); Paul A. Fino, New York, NY (US)

Correspondence Address: MORGAN, LEWIS & BOCKIUS, 1800 M STREET NW, WASHINGTON, DC, 20036-5869, US

(73) Assignee: Massmedium. com

(21) Appl. No.: 09/779,120

(22) Filed: Feb. 8, 2001

Related U.S. Application Data
(60) Provisional application No. 60/181,065, filed on Feb. 8, 2000.

(51) Int. Cl. G06F 17/60

(52) U.S. Cl. 705/14

(57) ABSTRACT

A method of providing a multi-level award program, using a system and a machine readable medium, the method including enrolling at least one first-level user, referred by the enrolled user, through a Web interface, tracking internet activity of the at least one first-level user, providing the at least one first-level user with award points earned by the at least one first-level user for the internet activity, and calculating bonus points awarded to the enrolled user based on a first percentage of the award points earned by the at least one first-level user. The system includes a database for receiving and storing information from a plurality of referred users at a plurality of levels, a database for receiving and storing award points, software for tracking internet activity of the referred users and providing award points to the referred users, and software for calculating bonus points awarded to the enrolled user based on percentages of the award points provided to the referred users. The machine readable medium includes a first machine readable code that enrolls the at least one first-level user referred by the enrolled user, a second machine readable code that tracks internet activity of the at least one first-level user, a third machine readable code that provides award points to the at least one first-level user for the internet activity of the at least one first-level user, and a fourth machine readable code that calculates the bonus points awarded to the enrolled user.

### REFERENCE TO RELATED APPLICATION

This application expressly claims the benefit of the earlier filing date and right of priority from the following patent application: U.S. Provisional Application Ser. No. 60/181,065, filed on Feb. 8, 2000 in the name of Christopher J. Heintz and Paul A. Fino and entitled “Internet Loyalty Program for Awarding Redeemable Points.” The entirety of that earlier filed co-pending provisional patent application is expressly incorporated herein by reference.

### FIELD OF THE INVENTION

The invention relates generally to internet incentive programs, and more specifically, to multi-level internet award programs.

### BACKGROUND OF INVENTION

The Internet may be used to research, find, and purchase products from various Websites. On one hand, it is believed that a simple and efficient means of finding vendors and low-price purchases are desired by customers. On the other hand, online vendors may seek methods to attract new customers to their website to build a base of repeat customers.

It is believed that one way to provide services to both customers and vendors is to provide incentives to customers for visiting or purchasing from vendors at various Websites. These incentives may be in the form of discounts or rewards for future use. It is believed that customers will visit vendors' Websites to earn these rewards. As such, it is further believed that customers will participate in other internet activities to earn rewards.

### SUMMARY OF THE INVENTION

The present invention provides a method of providing a multi-level award program for an enrolled user. This method includes enrolling at least one first-level user, referred by the enrolled user, through a Web interface, tracking internet activity of the at least one first-level user, providing the at least one first-level user with award points earned by the at least one first-level user for the internet activity, and calculating bonus points awarded to the enrolled user based on a first percentage of the award points earned by the at least one first-level user.

The present invention also provides another method of providing a multi-level award program for an enrolled user. This method includes enrolling a plurality of first-level users referred by the enrolled user, a plurality of second-level users referred by the first-level users, a plurality of third-level users referred by the second-level users, and a plurality of fourth-level users referred by the third-level users through a Web interface. This method further includes tracking internet activity of the first-level users, second-level users, third-level users, and fourth-level users, providing the first-level users, second-level users, third-level users, and fourth-level users with award points for the internet activity, and calculating bonus points awarded to the enrolled user based on a first percentage of the award points earned by the first-level users, a second percentage of the award points earned by the second-level users, a third percentage of the award points earned by the third-level users, a fourth percentage of the award points earned by the fourth-level users.

The present invention also provides a system for a multi-level award program for an enrolled user. The system includes a database for receiving and storing information from a plurality of referred users at a plurality of levels, a database for receiving and storing award points, software for tracking internet activity of the referred users and providing award points to the referred users, and software for calculating bonus points awarded to the enrolled user based on percentages of the award points provided to the referred users. In this system, the percentages vary with the levels.

The present invention further provides a machine readable medium that provides a multi-level award program for an enrolled user. The machine readable medium includes a first machine readable code that enrolls at least one first-level user referred by the enrolled user, a second machine readable code that tracks internet activity of the at least one first-level user, a third machine readable code that provides award points to the at least one first-level user for the internet activity of the at least one first-level user, and a fourth machine readable code that calculates bonus points awarded to the enrolled user based on a first percentage of the award points earned by the at least one first-level user.

### BRIEF DESCRIPTION OF THE DRAWINGS

The accompanying drawings, which are incorporated herein and constitute part of this specification, illustrate the presently preferred embodiment of the invention, and, together with the general description given above and the detailed description given below, serve to explain the features of the invention.

FIG. 1 is a block diagram of an enrollment and award process for the enrolled user of the multi-level award program.

FIG. 2 is a block diagram of an enrollment and award process for the first-level user and enrolled user of the multi-level award program.

FIG. 3 is a chart of the account summary.

FIG. 4 is a block diagram of a system for implementing the multi-level award program.

### DETAILED DESCRIPTION OF THE PREFERRED EMBODIMENTS

Reference will now be made in detail to the preferred embodiments of the present invention, examples of which are illustrated in the accompanying drawings. It is to be understood that the Figures and descriptions of the present invention included herein illustrate and describe elements that are of particular relevance to the present invention, while eliminating, for purposes of clarity, other elements found in typical award systems and computer networks.

The present invention provides a user-friendly multi-level award program that provides members with award points and an incentive to refer friends, family, co-workers and others to the program. The program uses host software and a Web interface to track members' visits or responses to promotional material and the members' qualified online purchases at third-party sites and to maintain an updated account of the members' award points. Preferably, the award program has a Web gateway interface with a site navigation bar, a categorized vendor list, member news and features, and login and help information.

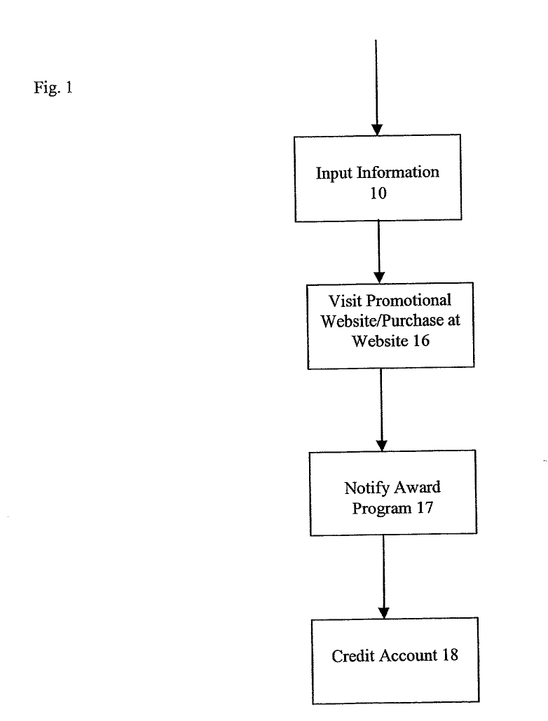

In order for the program to be able to track and maintain an account, the member must first become a member of the multi-level award program by providing some basic account information, a personal e-mail address, and a usemame, as shown in FIG. 1. In step 10, the sign-up interface for enrollment requires the user to input information, including a chosen username and password, along with some general demographic information (e.g., Zip, gender, date of birth, and referrer's name).

In step 16, the host system increments the member's account when the member visits an affiliated vendor's Website or the member makes a qualified purchase at a vendor's Internet site. Vendors who become affiliated with the program supply software that is integrated into the program's Internet site. If awards are based on visiting a Website, the software identifies the member and the member's account is credited simply by visiting the specific Internet sites. The software also identifies which members “click through” to the vendor's Internet site to browse or shop. The program can receive awards for “click through” or a percentage of the amount of purchase. The system may be configured to award the member points once or various times for subsequent visits to the promotional Internet site via the provided link.

The system may direct the member to the location of a Website by means of a link in an e-mail, a link on a Website, or by other promotional means. These links, which are provided to the program, identify the user as a member of the program. By choosing the link and visiting the Internet site of a third-party, the system identifies the member as a participant of the award program and the member can earn award points.

From the perspective of the member, the above described online transaction, which includes the earning of award points, will seem like any other visit or online purchase. However, the vendor will notify the award program of the visit or transaction in step 17. After notification, the system credits the account of the member in step 18.

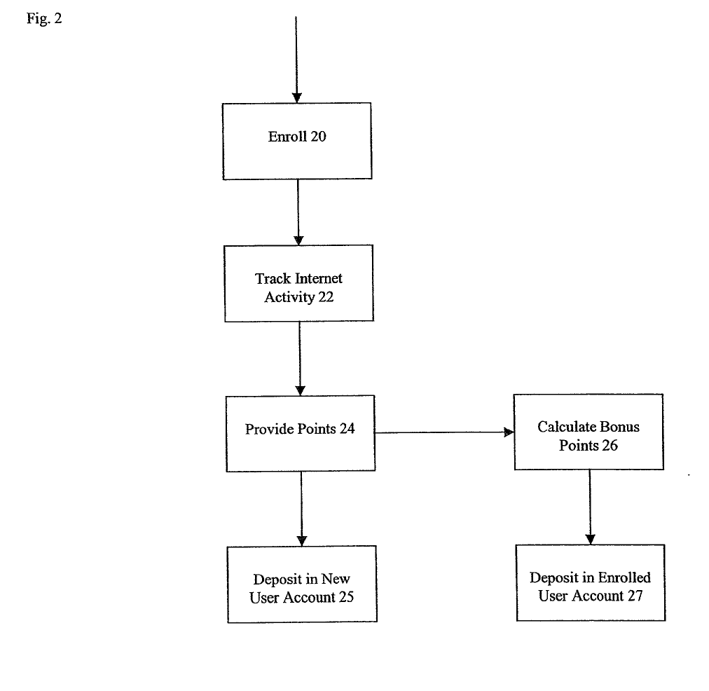

The program is also configured to credit the member's account for visits to a promotional Website made by users referred by the member. As shown in FIG. 2, the member (or enrolled user) refers a new user (or first-level user) to the award program on the internet. The member may refer the first-level user by providing the e-mail address of the first-level user, through the Web interface, to the award program, which then generates and sends an email message from the member to the first-level users. Alternatively, the member contacts and refers the first-level user independently of the award program. The first-level user may be a friend, family member, colleague, or any other individual the member may contact. The member may refer one or more first-level users to the award program at any time while enrolled. In step 20, each first-level user enrolls in the award program by signing-up through the interface as a result of a referral from the member. The sign-up entails an input of information for the first-level user, similar to the enrollment of the member in step 10. If the first-level user indicates that the member referred the first-level user to the award program, then the member will earn a percentage of the award points of the first-level user. Preferably, the first-level user indicates a referral by providing the username of the member. Once enrolled, the first-level user becomes a member, an account specific to the first-level user is maintained, and in step 22, the award program tracks the internet activity of the first-level user through vendors' Websites. The internet activity includes clicking or visiting Websites and shopping on the internet. The visiting Websites includes playing games, registering, answering trivia questions, signing up for a service or item, winning contests, taking surveys, and any other activity offered on the Internet.

Similar to steps 16-18 described above, in step 24, the award program provides points to the first-level user based on the Internet activity of the first level user. These award points are deposited into the account of the first-level user in step 25. In addition, the member that referred the first-level user to the award program receives bonus points based on the activities of the first-level user. These activities, preferably, include all of the internet activity in which the first-level user may receive points. For example, in step 26, a first percentage, such as 10%, is predetermined and used to calculate the bonus points to be awarded to the member for the referral (e.g. for every 10 points awarded to the first-level user, 1 bonus point will be awarded to the member that referred the first-level user to the award program). When the bonus points are calculated, the bonus points are deposited into the account of the member in step 27.

Similar to the referral by the member, the first-level user may refer one or more second-level users to the award program. The referral and enrollment of a second-level user will benefit both the first-level user and the member that referred the first-level user to the award program. During enrollment, if the second-level user indicates that the first-level user referred the second-level user to the award program, the first-level user will receive bonus points equal to a first percentage of the award points earned by the second-level user, and the member that referred the first-level user to the award program will receive a second percentage of the award points earned by the second-level user. The first percentage may be the same or different from the second percentage. In the preferred embodiment, the first percentage is about 10%, while the second percentage is about 5% (e.g., for every 20 bonus points awarded to the second-level user, 2 bonus points will be awarded to the first-level user that referred the second-level user to the award program, and 1 bonus point will be awarded to the member that referred the first-level user to the award program.) The bonus points may also be based on a proportion, fraction, or portion of any user's earned award points.

Additionally, third-level users may be referred by the second-level users and fourth-level users may be referred by the third-level users using the method described above. In this case, the member will receive, in addition to the bonus points equal to percentages of points earned by the first- and second-level users, bonus points equal to a third percentage of the award points earned by the third-level user and a fourth percentage of the award points earned by the fourth-level user. Preferably the third and fourth percentages are the same as the second percentage, and more preferably, about 5%. Similarly, the first-level user will receive, in addition to the bonus points earned from the second-level user, bonus points equal to a second and third percentage of the award points earned by the third- and fourth-level users, respectively. The third-level user will also receive bonus points equal to a first percentage of the award points earned by the fourth-level user.

The system not only awards the members and referred users, but facilitates communication between members and referred users. This participation may or may not be rewarded, but is provided for the benefit of the members and the referred users. For example, all of the first-level users that were referred by the member may participate in a game against each other or participate in a chat board with one another. In addition, bonus points may be earned by one referred user recommending products to another referred user or challenging another referred user to a trivia game.

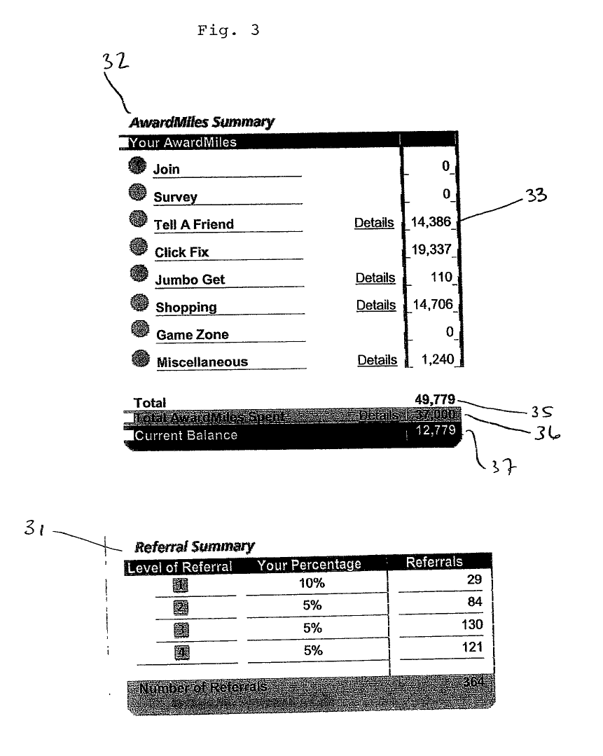

Once enrolled, a member or any other enrolled user may view their account information, which is maintained by the host software, through the Web interface. The preferred account summary, as shown in FIG. 3, includes a referral summary 31 and award points summary 32. The referral summary 32, preferably, displays the number of referrals in each level and the percentages used to calculate bonus points based on the referred users' Internet activity. The award points summary 33, preferably, displays points by way of how they were earned, the total points 35 earned, the spent points 36 that have been redeemed, and the current balance 37 of points available. The bonus points 33 awarded from referrals are, preferably, of equal value to all of the points in the award points summary and are included in the total points 35. In regard to the spent points 36, after sufficient points for an award have been earned, the system allows the member to redeem points through the Web interface. The awards offered may be movie tickets, gift certificates, travel vouchers, discounts or any other item. A preferred awards interface shows awards available and the number of award points required. After award points have been redeemed and an award chosen, the system processes the request and updates the member's account by adding points to the spent points 36 and subtracting points from the current balance 37.

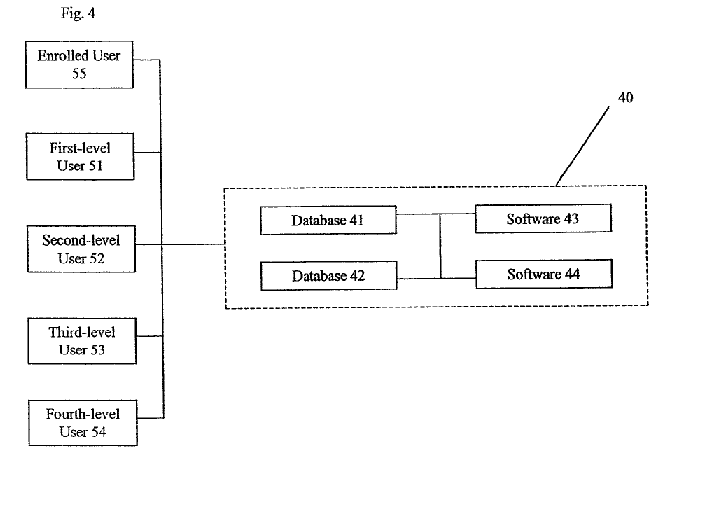

As shown in FIG. 4, the system 40 that implements the multi-level program includes a database 41, a database 42, software 43 and software 44. Database 41 receives and stores information from referred users, including the first-level user 51, second-level user 52, third-level user 53, and fourth-level user 54. Database 42 receives and stores award points. Software 43 tracks internet activity of the referred users 51, 52, 53 and 54 and provides award points to the referred users 51, 52, 53 and 54. Software 44 calculates bonus points awarded to the enrolled user 55 based on percentages of the award points provided to the referred users 51, 52, 53 and 54.

The multi-level program further includes a first machine readable code that enrolls the first-level users referred by the enrolled user, a second machine readable code that tracks internet activity of the first-level users, a third machine readable code that provides award points to the first-level users for the internet activity of the first-level users, and a fourth machine readable code that calculates bonus points awarded to the enrolled user based on a first percentage of the award points earned by the first-level users.

While the invention has been described in detail and with reference to specific features, it will be apparent to one skilled in the art that various changes and modifications can be made therein without departing from the spirit and scope of the invention. For example, the multi-level award program may have more than four levels or may reward members with another reward medium besides points. It is intended that the present invention cover the modifications and variations of this invention provided they come within the scope of the appended claims and their equivalents.

What is claimed is:

1. A method of providing a multi-level award program for an enrolled user comprising:
enrolling at least one first-level user, referred by the enrolled user, through a Web interface;
tracking internet activity of the at least one first-level user;
providing the at least one first-level user with award points earned by the at least one first-level user for the internet activity; and
calculating bonus points awarded to the enrolled user based on a first percentage of the award points earned by the at least one first-level user.

2. The method of claim 1 further comprising:
enrolling at least one second-level user, referred by the at least one first-level user, through the Web interface;
tracking internet activity of the at least one second-level user;
providing the at least one second-level user with award points earned by the at least one second-level user for the internet activity; and
calculating bonus points awarded to the enrolled user based on a second percentage of the award points earned by the at least one second-level user.

3. The method of claim 2 further comprising:
calculating bonus points awarded to the at least one first level user based on a proportion of the award points earned by the at least one second-level user.

4. The method of claim 2 further comprising:
enrolling at least one third-level user, referred by the at least one second-level user, through the Web interface;
tracking internet activity of the at least one third-level user; providing the at least one third-level user with award points earned by the at least one third-level user for the internet activity; and
calculating bonus points awarded to the at least one second-level user based on a third percentage of the award points earned by the at least one third-level user.

5. The method of claim 4 further comprising:
calculating bonus points awarded to the at least one first-level used based on a first proportion of the award points earned by the at least one second-level user and a second proportion of the award points earned by the at least one third-level user; determining bonus points awarded to the at least one second-level user based on a fraction of the award points earned by the at least one third-level user.

6. The method of claim 4 further comprising:
enrolling at least one fourth-level user, referred by the at least one third-level user, through the Web interface;
tracking internet activity of the at least one fourth-level user;
providing the at least one fourth-level user with award points earned by the at least one fourth-level user for the internet activity; and
calculating bonus points awarded to the enrolled user based on a fourth percentage of the award points earned by the at least one fourth-level user.

7. The method of claim 6 comprising:
calculating bonus points awarded to the at least one first-level user based on a first proportion of the award points earned by the at least one second-level user and a second proportion of the award points earned by the at least one third-level user and a third proportion of the award points earned by the at least one fourth level user;
determining bonus points awarded to the at least one second-level user based on a first fraction of the award points earned by the at least one third-level user and a second fraction of the award points earned by the at least one fourth-level user; and crediting bonus points to the at least one third-level user based on a portion of the award points earned by the at least one fourth-level user.

8. The method of claim 2 wherein the calculating comprises:
assigning a first percentage rate to the internet activity of the at least one first-level user and a second percentage rate to the internet activity of the at least one second-level user.

9. The method of claim 8 wherein the assigning comprises:
specifying a value of about 10% as the first percentage rate and a value of about 5% as the second percentage rate.

10. The method of claim 8 further comprising:
assigning the second percentage rate to the at least one third-level user and the at least one fourth-level user.

11. The method of claim 1 further comprising:
displaying a referral summary in an account of the enrolled user through the Web interface.

12. The method of claim 1 further comprising:
supplying an e-mail address of the at least one first-level user through the Web interface; and
sending an e-mail message from the enrolled user to the address.

13. The method of claim 1 wherein the providing comprises:
earning the award points by at least one of shopping, clicking, visiting, playing games, registering, answering trivia, signing up for a service or item, winning contests and taking surveys on Websites.

14. The method of claim 1 further comprising:
directing the at least one first-level user to affiliated vendors.

15. The method of claim 1 wherein the tracking comprises:
monitoring visits by the at least one first-level user to promotional internet sites.

16. The method of claim 1 wherein the providing comprises:
crediting the at least one first-level user for visiting promotional internet sites.

17. The method of claim 1 wherein the providing comprises:
crediting the at least one first-level user for purchases made at a vendor's internet site.

18. The method of claim 1 further comprising:
redeeming the award points of the first-level user through the Web interface.

19. The method of claim 1 further comprising:
adding the bonus points to loyalty points earned by the enrolled user; and
redeeming the loyalty points earned by the enrolled user through the Web interface.

20. The method of claim 1 further comprising:
updating an account of the at least one first-level user after redemption of the award points earned by the at least one first-level user.

21. The method of claim 1 wherein the bonus points are deposited with loyalty points of the enrolled user into an account of the enrolled user, further comprising:
updating the account of the enrolled user after a redemption of loyalty points by the enrolled user.

22. A method of providing a multi-level award program for an enrolled user comprising:
enrolling a plurality of first-level users referred by the enrolled user, a plurality of second-level users referred by the first-level users, a plurality of third-level users referred by the second-level users, and a plurality of fourth-level users referred by the third-level users through a Web interface;
tracking internet activity of the first-level users, second-level users, third-level users, and fourth-level users;
providing the first-level users, second-level users, third-level users, and fourth-level users with award points for the internet activity; and
calculating bonus points awarded to the enrolled user based on a first percentage of the award points earned by the first-level users, a second percentage of the award points earned by the second-level users, a third percentage of the award points earned by the third-level users, a fourth percentage of the award points earned by the fourth-level users.

23. The method of claim 22 wherein the calculating comprises:
decreasing a value of percentage from the first percentage to the second percentage to the third percentage to the fourth percentage.

24. A system for a multi-level award program for an enrolled user comprising:
a database for receiving and storing information from a plurality of referred users at a plurality of levels;
a database for receiving and storing award points; software for tracking internet activity of the referred users and providing award points to the referred users; and
software for calculating bonus points awarded to the enrolled user based on percentages of the award points provided to the referred users, wherein the percentages vary with the levels.

25. The system of claim 24 wherein the internet activity comprises at least one of shopping, clicking, visiting, playing games, registering, answering trivia, signing up for a service or item, winning contests and taking surveys on Websites.

26. The system of claim 24 wherein the plurality of referred users comprises at least one first-level user referred by the enrolled user and at least one second-level user referred by the at least one first-level user and the percentages comprise a first percentage rate for the at least one first-level user and a second percentage rate for the at least one second-level user.

27. The system of claim 26 wherein the plurality of referred users further comprises at least one third-level user referred by the at least one second-level user and at least one fourth-level user referred by the at least third level user and the second percentage rate applies to the at least one third-level user referred by the at least one second-level user and the at least one fourth-level user referred by the at least third-level user.

28. The system of claim 26 wherein the first percentage rate comprises a value of about 10% and the second percentage rate comprises a value of about 5%.

29. A machine readable medium that provides a multi-level award program for an enrolled user comprising:
a first machine readable code that enrolls at least one first-level user referred by the enrolled user; a second machine readable code that tracks internet activity of the at least one first-level user;
a third machine readable code that provides award points to the at least one first-level user for the internet activity of the at least one first-level user; and
a fourth machine readable code that calculates bonus points awarded to the enrolled user based on a first percentage of the award points earned by the at least one firstlevel user.

30. The machine readable medium of claim 29 wherein the first machine readable code enrolls at least one second-level user referred by the at least one first-level user, at least one third-level user referred by the at least one second-level user, and at least one fourth-level user referred by the at least one third-level user.

31. The machine readable medium of claim 30 wherein the second machine readable code tracks internet activity of the at least one second-level user, the at least one third-level user, and the at least one fourth-level user.

32. The machine readable medium of claim 31 wherein the third machine readable code provides award points to the at least one second-level user for the internet activity of the at least one second-level user, the at least one third-level user for the internet activity of the at least one third-level user, and the at least one fourth-level user for the internet activity of the at least one fourth-level user.

33. The machine readable medium of claim 32 wherein the fourth machine readable code calculates bonus points awarded to the enrolled user based on a second percentage of the award points earned by the at least one second-level user, a third percentage of the award points earned by the at least one third-level user, and a fourth percentage of the award points earned by the at least one fourth-level user.
